(19) United States
(12) Patent Application Publication
(10) Pub. No.: US 2014/0178532 A1
(43) Pub. Date: Jun. 26, 2014

(54) Beverage Mixing Apparatus and Methods of Making and Using the Same

(71) Applicants: Brett I. Walker, Island Lake, IL (US); Maria A. Walker, Island Lake, IL (US)

(72) Inventors: Brett I. Walker, Island Lake, IL (US); Maria A. Walker, Island Lake, IL (US)

(21) Appl. No.: 13/793,985

(22) Filed: Mar. 11, 2013

Related U.S. Application Data
(60) Provisional application No. 61/740,289, filed on Dec. 20, 2012.

(51) Int. Cl. B65D 85/812; B31F 1/00

(52) U.S. Cl. CPC B65D 85/812; B31F 1/00
USPC 426/78; 426/82; 426/79; 426/425; 493/393

(57) ABSTRACT

The present invention relates to a beverage mixing apparatus. Specifically, the present invention relates to a filter containing coffee, tea, or another additive to be mixed with a liquid. The filter is formed into a ball and attached to a rigid stick for stirring and mixing the contents of the present invention into a liquid. The filter may keep solid beverage additives separate from the liquid while still allowing the two to mix. Soluble additives may pass freely through the filter.

The present invention claims priority as a non-provisional application of U.S. provisional application No. 61/740,289 filed Dec. 20, 2012, which is incorporated by reference herein in its entirety.

### TECHNICAL FIELD

The present invention relates to a beverage mixing apparatus. Specifically, the present invention relates to a filter containing coffee, tea, or another additive to be mixed with a liquid. The filter is formed into a ball and attached to a rigid stick for stirring and mixing the contents of the present invention into a liquid. The filter may keep solid beverage additives separate from the liquid while still allowing the two to mix. Soluble additives may pass freely through the filter.

### BACKGROUND

It is, of course, generally known to mix additives into liquids. People have been mixing leaves or herbs into boiling water to make tea for thousands of years. Tea is generally known to benefit overall heath because it contains amino acids, vitamins, caffeine, and other beneficial extracts. It has even been suggested that tea may protect against diseases, such as cancer.

In some cultures, tealeaves are mixed with water directly without any straining method. The tealeaves flavor the water in which they are mixed, but often the leaves are consumed along with the tea. Drinking solids along with liquids can present a choking hazard.

Generally, tealeaves are strained from tea after mixing. This eliminates the choking hazard while still allowing flavoring additives. After the leaves are strained from the tea, however, the flavor consistency remains constant. Additional leaves may be added and then strained again for more flavor, but this is a time consuming process.

Commonly, teabags are used to mix tealeaves with water. Teabags create an enclosure around the tealeaves while allowing water to flow through. When the desired flavor consistency has been met, the teabag may be removed without leaving any leaves behind. Tea drinkers may speed the mixing process by dunking a teabag into the water using an attached string. The flaccid nature of both the teabag and the attached string make mixing inefficient. Further, teabags are compact and do not provide much surface area for water to mix with the enclosed tealeaves.

Recently, pyramidal teabags have been introduced to provide a larger surface area for water to mix within the enclosed teabags. Pyramidal teabags, like regular teabags, are generally tied to a string, wherein both the pyramidal teabag and the string are flaccid. This makes stirring the pyramidal teabag inefficient as well.

Commonly, tea drinkers may squeeze or squish a teabag within the water to release more flavor into the water. This is difficult to do without additional tools because of the flaccid nature of the teabag.

Alternatively, metal tea enclosures may be used. The metal tea enclosures are filled with loose tealeaves and then placed within the water. Tea drinkers may stir the metal tea enclosure with chains or metal rods. These metal tea enclosures need to be washed, do not come with tealeaves, require preparation time, and generally cannot be squished or squeezed to release extra flavoring.

Frequently, people enjoy drinking coffee. Coffee comes from beans that need to be ground up before being mixed with boiling water. This mixture requires filtering water and coffee grounds. Generally, most people use a percolator to make coffee. In a percolator, coffee grounds are first placed into a filter. Then boiling water is run through the coffee grounds. The coffee grounds and water mixture then runs through a filter to remove the solids from the mixture. Often, this process does not completely filter out all of the coffee grounds.

Additionally, coffee may be made using a French press. In a French press, coffee grounds are mixed with boiling water in a cylindrical device. After a few minutes, a plunger is used to push the coffee grounds to the bottom of the French press while straining the coffee. This method makes stronger coffee because the grounds remain in direct contact with the water instead of the water just passing through the grounds. These methods of brewing coffee require bulky machinery.

Frequently, other beverage additives are added to water to make juices, flavored water, tea, coffee, or hot chocolate. These instant mixes commonly are mixed with water with a spoon or other stirring device. Unlike tealeaves or coffee grounds, these instant mixes completely dissolve into water. Unfortunately, these instant mixes generally come in large containers and not individual servings.

A need exists, therefore, for a rigid beverage mixing apparatus.

Specifically, a need exists for an apparatus that holds a quantity of beverage additives.

More specifically, a need exists for an apparatus that can mix the beverage additives efficiently with water.

Also, a need exists for an apparatus with a large surface area for mixing water and beverage additives.

Furthermore, a need exists for an apparatus that may be squished to release extra flavoring.

Moreover, a need exists for an apparatus that can keep solid beverage additives separate from the water.

Additionally, a need exists for a disposable apparatus that may be packaged for individual servings.

### SUMMARY OF THE INVENTION

The present invention relates to a beverage mixing apparatus. Specifically, the present invention relates to a filter containing coffee, tea, or another additive to be mixed with a liquid. The filter is formed into a ball and attached to a rigid stick for stirring and mixing the contents of the present invention into a liquid. The filter may keep solid beverage additives separate from the liquid while still allowing the two to mix. Soluble additives may pass freely through the filter.

To this end, in an embodiment of the present invention, a beverage mixing apparatus is provided. The beverage mixing apparatus comprises a first end, a second end, and a length between the first end and the second end, wherein a spherical filter is disposed on the first end and a rigid stick is disposed on the second end, further wherein a beverage additive is contained within the spherical filter.

In an alternate embodiment of the present invention, a method for making a beverage mixing apparatus is provided. The method for making the beverage mixing apparatus comprises the steps of providing a filter, placing a beverage additive on the filter, forming the filter and beverage additive combination into a sphere, and spinning a quantity of paper around the filter and beverage additive combination to form a stick.

In an alternate embodiment of the present invention, a method for using a beverage mixing apparatus is provided. The method for using the beverage mixing apparatus comprises the steps of providing an amount of boiling water; providing a beverage mixing apparatus having a spherical filter disposed on a first end and a rigid stick disposed on a second end, wherein a beverage additive is contained within the spherical filter; inserting the beverage mixing apparatus into the boiling water; and stirring the beverage mixing apparatus in the boiling water.

It is, therefore, an advantage and objective of the present invention to provide a rigid beverage mixing apparatus.

Specifically, it is an advantage and objective of the present invention to provide an apparatus that holds a quantity of beverage additives.

More specifically, it is an advantage and objective of the present invention to provide an apparatus that can mix the beverage additives efficiently with water.

Also, it is an advantage and objective of the present invention to provide an apparatus with a large surface area for mixing water and beverage additives.

Furthermore, it is an advantage and objective of the present invention to provide an apparatus that may be squished to release extra flavoring.

Moreover, it is an advantage and objective of the present invention to provide an apparatus that can keep solid beverage additives separate from the water.

Additionally, it is an advantage and objective of the present invention to provide a disposable apparatus that may be packaged for individual servings.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present embodiments, by way of example only, not by way of limitations. In the figures, like reference numerals refer to the same or similar elements.

FIG. 1 illustrates a filter with a beverage additive on it in an embodiment of the present invention.

FIG. 2 illustrates a filter with a beverage additive formed into a sphere in an embodiment of the present invention.

FIG. 3 illustrates a side view of a spherical filter with a beverage additive being wrapped in paper in an embodiment of the present invention.

FIG. 4 illustrates a side view of a spherical filter with a beverage additive being wrapped tighter in paper in an embodiment of the present invention.

FIG. 5 illustrates a side view of the beverage mixing apparatus in a preferred embodiment of the present invention.

FIG. 6 illustrates a perspective view of a beverage mixing apparatus in a cup of water in an embodiment of the present invention.

FIG. 7 illustrates a cross-sectional view of a beverage mixing apparatus in a cup of water in an embodiment of the present invention.

FIG. 8 illustrates a cross-sectional view of a beverage mixing apparatus dispersing beverage additive into a cup of water in an embodiment of the present invention.

FIG. 9 illustrates a side view of a beverage mixing apparatus in an alternate embodiment of the present invention.

FIG. 10 illustrates a side view of a beverage mixing apparatus in an alternate embodiment of the present invention.

FIG. 11 illustrates a side view of another beverage mixing apparatus in yet another alternate embodiment of the present invention.

### DETAILED DESCRIPTION OF THE PRESENTLY PREFERRED EMBODIMENTS

The present invention relates to a beverage mixing apparatus. Specifically, the present invention relates to a filter containing coffee, tea, or another additive to be mixed with a liquid. The filter is formed into a ball and attached to a rigid stick for stirring and mixing the contents of the present invention into a liquid. The filter may keep solid beverage additives separate from the liquid while still allowing the two to mix. Soluble additives may pass freely through the filter.

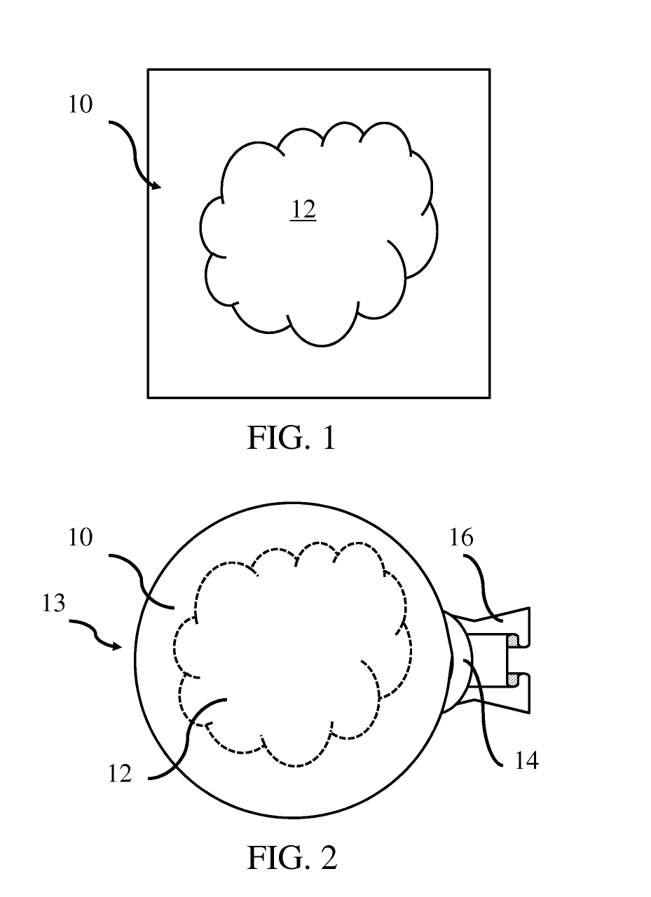

Now referring to the figures, wherein like numerals refer to like parts, FIG. 1 illustrates a filter 10 with a beverage additive 12 disposed thereon. The beverage additive 12 may be coffee, tea, a soluble flavoring, of other additive known to one skilled in the art. The filter 10 may be circular, rectangular, polygonal, or any other shape known to one skilled in the art. The filter 10 may be porous so that water and soluble substances may pass through, however, may prevent solid substances, such as coffee grounds or tealeaves, from passing through. The filter 10 may be spherically formed to create a beverage additive sphere 13, as shown in FIG. 2, with the beverage additive 12 disposed therein. Filter materials known to those of ordinary skill in the art may be used, such as paper filters, threaded filters, plastic filters, or any other known filter. Moreover, a tie 14 may be used to tie together the edges of filter 10 and form a knot 16. Of course, a clip, string, wire, fastener, or other manner of tying together the edges of the filter together, as described herein. The tie 14 and knot 16 may prevent the beverage additive 12 from escaping the beverage additive sphere 13.

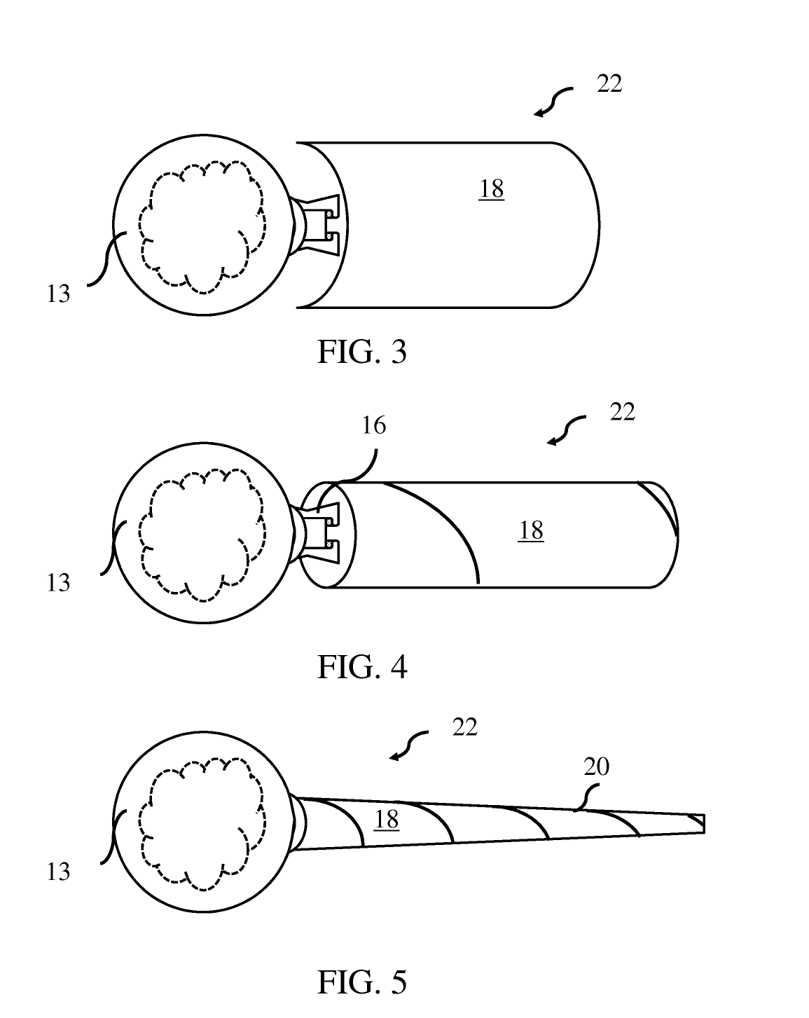

As shown in FIGS. 3-5, a beverage additive pop making process is shown and described. The beverage additive pop 22 may be created by tightly winding the beverage additive sphere 13 with a paper 18, as shown in FIG. 3. However, it should be noted that the paper 18, utilized to create the rigid handle for holding the filter thereon, may be made from any other material useful for providing the functionality and advantages described herein. For example, the paper 18 may actually be made from a plastic sheet, or the like, that may be helically wound, as described herein.

The paper 18 may be helically rotated around the knot 16, as shown in FIG. 4. The paper 18 may completely encapsulate the knot 16 and conically extend away from the beverage additive sphere 13. The paper 18 may alternatively cylindrically extend away from the beverage additive sphere 13, or extend in any shape known to one skilled in the art. The paper 18 may be coated in an adhesive (not shown) or other bonding substance known to one skilled in the art such that the paper 18 cements to itself and the knot 16. The paper 18 may be tightly wound such that it forms a rigid stick 20, as shown in FIG. 5. The rigid stick 20 may not deteriorate when placed in a liquid. The paper 18 may be wound by a lollipop machine, by hand, or by a similar method known to one skilled in the art. The beverage additive pop 22 shown in FIG. 5 may then be packaged, sealed, and shipped to consumers.

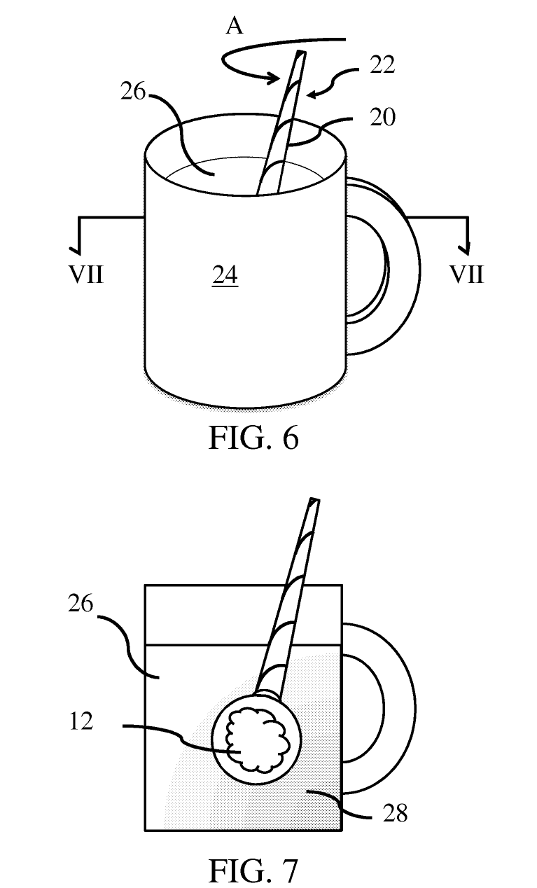

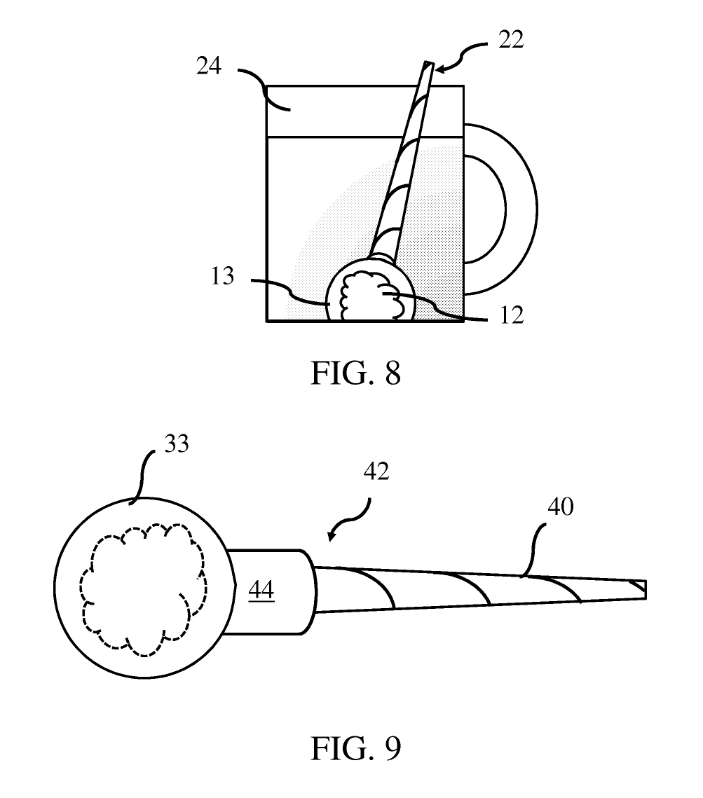

The beverage additive pop 22 may be inserted into a cup 24 full of a liquid 26, preferably boiling water, as seen in FIG. 6. The beverage additive pop 22 may be stirred efficiently along a path A by using the rigid stick 20. As the beverage additive pop 22 is stirred within the liquid 26, the beverage additive 12 and liquid 26 may mix to form a beverage 28, as shown in FIG. 7. Alternatively as shown in FIG. 8, the beverage additive pop 22 may be squished against the bottom or sides of the cup 24, releasing extra flavoring from the beverage additive sphere 13. Squishing the beverage additive pop 22, when the beverage additive 12 is coffee, may simulate the function of a French Press without requiring a French Press.

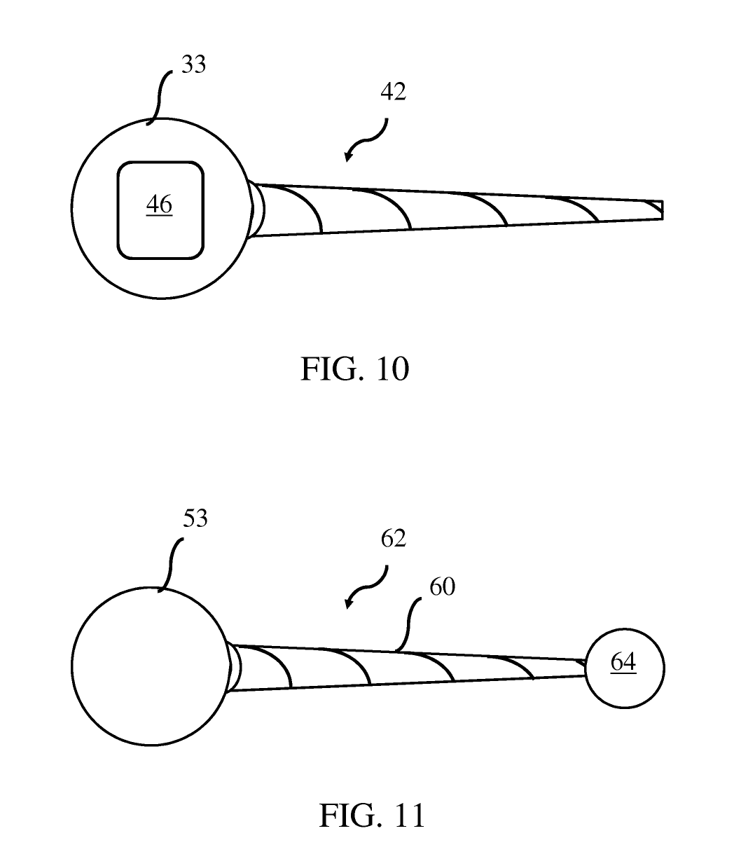

In FIGS. 9-10, a beverage additive pop 42 is shown and described in an alternate embodiment of the present invention. A beverage additive sphere 33 may be disposed on a first end of the beverage additive pop 42 and a rigid stick 40 may be disposed a second end of the beverage additive pop 42. An additional additive packet 44 may be attached at the base of the beverage additive sphere 33, overlapping the rigid stick 40 as shown in FIG. 9. Alternatively, an additional additive packet 46 may be attached directly to the beverage additive sphere 33 as shown in FIG. 10. The additional additive packets 44, 46 may contain an amount of sugar, dehydrated lemon, milk, crystallized lemon juice, or other additional additive flavoring known to one skilled in the art. The additional additive packets 44, 46 may be permeable like the beverage additive sphere such that a user may mix the additional additive packets into a liquid as described above. Alternatively the additional additive packets 44, 46 may be mixed into a liquid by tearing the additional additive packets 44, 46 and pouring the contents into the liquid. There may be more than one additional additive packets 44, 46 such that a user may be able to apportion additional flavor to taste.

In FIG. 11, a beverage additive pop 62 is shown and described in an alternate embodiment of the present invention. A beverage additive sphere 53 may be disposed on a first end of the beverage additive pop 62, a safety end 64 may be disposed on a second end of the beverage additive pop 62, and a rigid stick 60 may be disposed between the first end and the second end. The safety end 64 may prevent harm by avoiding any sharp ends to the rigid stick 60. The safety end 64 may be used to stir the beverage additive pop 62 within a liquid (not shown). Of course, the shape of the safety end 64 may be any shape known to one skilled in the art, however, may preferably be arcuate. The safety end 64 may be rigid similar to the rigid stick 60, however, may also be permeable similar to the beverage additive sphere 53. When the safety end 64 is permeable, additional additive flavoring (not shown) may be disposed therein, such that a user may optionally add additional additive flavoring (not shown) by using beverage additive sphere 53 within a liquid (not shown), turning beverage additive pop 62 over, and then using safety end 64 within the liquid. Of course, the beverage additive pop 62 may be used in reverse order, bent to allow both the beverage additive sphere 53 and the safety end 64 to be used simultaneously, or any combination thereof.

Alternatively, the beverage additive sphere may be disposed around the rigid stick. The beverage additive may be contained within the beverage additive sphere as previously described above. Further, the rigid stick may be compartmentalized to form a plurality of chambers within the rigid stick. A plurality of additional additive flavoring may be disposed within the plurality of chambers within the rigid stick. The additional additive flavoring may be sugar, dehydrated lemon, milk, crystallized lemon juice, or other additional additive flavoring as described above. A plurality of breakable seals may separate each chamber and the beverage additive sphere such that a user may add additional additive flavoring to the beverage additive sphere by applying force to the plurality of breakable seals. In this way, a user may be able to optionally portion an amount of additional additive flavoring to taste.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. An apparatus for mixing additives into liquids, the apparatus comprising:
a malleable filter having a three dimensional shape;
a rigid stick having a first end and a second end, wherein the filter is joined with the rigid stick on the first end of the rigid stick; and
a first additive, wherein the first additive is contained within the filter.

2. The apparatus of claim 1 wherein the filter is spherically shaped.

3. The apparatus of claim 1 wherein the rigid stick is funnel shaped.

4. The apparatus of claim 1 wherein the rigid stick is cylindrically shaped.

5. The apparatus of claim 1 further comprising:
a cavity within the rigid stick;
at least one compartment disposed within the cavity, wherein a second additive is disposed therein; and
at least one breakable seal disposed between the at least one compartment and the filter, wherein the second additive enters the filter when the at least one breakable seal is broken.

6. The apparatus of claim 1 wherein the first additive is soluble, and further wherein the filter releases the first additive when the breakable seal is broken.

7. The apparatus of claim 1 wherein the first additive is insoluble, and further wherein the filter retains the first additive.

8. The apparatus of claim 1 further comprising an arcuate end disposed on the second end of the rigid stick.

9. The apparatus of claim 1 further comprising at least one packet containing a second additive disposed between the filter and the rigid stick, wherein the second additive is different from the first additive.

10. The apparatus of claim 1 further comprising at least one packet containing a second additive disposed on the filter, wherein the second additive is different from the first additive.

11. A method for creating a mixing apparatus, the method comprising the steps of:
providing a filter having a plurality of sides;
providing a first additive;
wrapping the filter around the first additive; and
joining the sides of the filter, wherein a length of filter extends away from the first additive.

12. The method of claim 11 further comprising the steps of:
providing a piece of paper having a first end and a second end; and
wrapping the first end of the piece of paper around the length of filter.

13. The method of claim 12 further comprising the step of:
forming the piece of paper into a rigid cone.

14. The method of claim 12 further comprising the step of:
forming the piece of paper into a rigid cylinder.

15. The method of claim 12 further comprising the step of:
attaching an arcuate end to the second end of the piece of paper.

16. A method for using a mixing apparatus, the method comprising the steps of:
providing an apparatus comprising a malleable filter having a three dimensional shape disposed on a first end of the apparatus, a rigid stick, wherein the filter is joined with the rigid stick, and a first additive, wherein the first additive is contained within the filter;
providing a cup of a liquid; and
inserting the first end of the apparatus into the cup of liquid.

17. The method of claim 16 further comprising the step of:
stirring the apparatus around the cup of liquid.

18. The method of claim 16 further comprising the step of:
pressing the apparatus against the cup.

19. The method of claim 16 further comprising the step of:
providing a permeable container disposed on a second end of the apparatus, wherein a second additive is disposed therein;
removing the first end of the apparatus from the cup of liquid; and
inserting the second end of the apparatus into the cup of liquid.

20. The method of claim 16 further comprising the step of:
providing a container disposed on a second end of the apparatus, wherein a second additive is disposed therein;
opening the container; and
pouring the contents of the container into the cup of liquid.
